(19) United States
(12) Patent Application Publication
(10) Pub. No.: US 2026/0185846 A1
(43) Pub. Date: Jul. 2, 2026

(54) TRACKING AUTONOMOUS VEHICLES USING REAL-TIME DATA

(71) Applicant: International Business Machines Corporation, Armonk, NY (US)

(72) Inventors: Hamid Majdabadi, Ottawa (CA); Jun Su, Beijing (CN); Su Liu, Austin, TX (US); Zhi Li Guan, Beijing (CN)

(21) Appl. No.: 19/007,659

(22) Filed: Jan. 2, 2025

(51) Int. Cl. G01C 21/00; G16Y 10/40; G16Y 40/10; H04L 67/12

(52) U.S. Cl. CPC G01C 21/3807; G01C 21/3841; G16Y 10/40; G16Y 40/10; H04L 67/12

(57) ABSTRACT

A computer-implemented method is provided. A processor set determines a set of data to be collected from a number of autonomous vehicles in real-time. The set of data comprises anonymized data associated with operations for the number of autonomous vehicles. The processor set collects the set of data from the number of autonomous vehicles through internet of things (IoT) devices from the number of autonomous vehicles using a central server. The processor set generates a digital map based on the set of data, wherein locations for the number of autonomous vehicles are shown in the digital map. The processor set displays the digital map to a number of users within a predefined proximity to the number of autonomous vehicles.

### BACKGROUND

The disclosure relates generally to tracking autonomous vehicles using real-time data.

Autonomous vehicles are designed to navigate and operate without human intervention by utilizing a range sensors, cameras, and advanced algorithms. These vehicles use artificial intelligence (AI), machine learning, and high-resolution mapping to understand and respond to their surroundings. For example, autonomous vehicles can detect obstacles, recognize traffic signals, interpret road signs, and understand lane markings using arrays of technologies such as light detection and ranging (LiDAR), radar, Global Positioning Service (GPS), and computer visions.

One of the primary objectives of autonomous vehicle development is to enhance road safety by minimizing human error, which is a leading cause of traffic accidents worldwide. In this case, autonomous vehicles can respond to changes in road conditions, follow traffic laws consistently, and maintain optimal distance from other vehicles by removing human interventions.

The impact of autonomous vehicles extends beyond individual transportation, potentially reshaping urban infrastructure and traffic flow. With optimized driving patterns and reduced congestion, autonomous vehicles can lower emissions and contribute to a more sustainable transport model.

### SUMMARY

According to one illustrative embodiment, a computer-implemented method is provided. A processor set determines a set of data to be collected from a number of autonomous vehicles in real-time. The set of data comprises anonymized data associated with operations for the number of autonomous vehicles. The processor set collects the set of data from the number of autonomous vehicles through internet of things (IoT) devices from the number of autonomous vehicles using a central server. The processor set generates a digital map based on the set of data, wherein locations for the number of autonomous vehicles are shown in the digital map. The processor set displays the digital map to a number of users within a predefined proximity to the number of autonomous vehicles. According to other illustrative embodiments, a computer system, and a computer program product are also provided.

### BRIEF DESCRIPTION OF THE DRAWINGS

FIG. 1 is a pictorial representation of a computing environment in which illustrative embodiments may be implemented;

FIG. 2 is an illustration of a block diagram of a vehicle information management environment in accordance with an illustrative embodiment;

FIG. 3 is an illustration of a digital map in accordance with an illustrative embodiment;

FIG. 4 is a flowchart of a process for presenting information of nearby autonomous vehicles in accordance with an illustrative embodiment;

FIG. 5 is a flowchart of a process for collecting data from autonomous vehicles in accordance with an illustrative embodiment;

FIG. 6 is a flowchart of a process for optimizing traffic signage and placement of road obstacles in accordance with an illustrative embodiment; and

FIG. 7 is a block diagram of a data processing system in accordance with an illustrative embodiment.

### DETAILED DESCRIPTION

A computer implemented method is provided. A processor set determines a set of data to be collected from a number of autonomous vehicles in real-time. The set of data includes anonymized data associated with operations for the number of autonomous vehicles. The processor set collects the set of data from the number of autonomous vehicles through internet of things (IoT) devices from the number of autonomous vehicles using a central server. The processor set generates a digital map based on the set of data. Locations for the number of autonomous vehicles are shown in the digital map. The processor set displays the digital map to a number of users within a predefined proximity to the number of autonomous vehicles. As a result, the illustrative embodiments provide a technical effect of identifying and displaying autonomous vehicles around particular users to promote awareness among drivers about the presence of vehicles in autonomous mode.

In the illustrative embodiments, as part of collecting the set of data from the number of autonomous vehicles through internet of things (IoT) devices from the number of autonomous vehicles, the processor set defines a communication protocol to allow the number of autonomous vehicles to transmit the set of data to the central server. The processor set identifies the internet of things devices from the number of autonomous vehicles. The internet of things devices are associated with operations for the number of autonomous vehicles. The processor set establishes connections between the internet of things devices from the number of autonomous vehicles and the central server. The processor set transmits the set of data collected from the internet of things devices to the central server. As a result, the illustrative embodiments provide a technical effect of establishing secure communications between internet of things devices from autonomous vehicles to central servers for data exchange.

In the illustrative embodiments, the transmission for the set of data is enabled when vehicles from the number of autonomous vehicles are engaged in self-driving autonomous mode. As a result, the illustrative embodiments provide a technical effect of identifying autonomous vehicles that drive around particular users without human interventions to promote awareness among drivers about the presence of vehicles in fully autonomous mode.

In the illustrative embodiments, the processor set optimizes traffic signage and placement of road obstacles based on the digital map. As a result, the illustrative embodiments provide a technical effect of improving traffic conditions by utilizing the information of autonomous vehicles in an area.

In the illustrative embodiments, the number of users includes pedestrians and users from establishments within the predefined proximity to the number of autonomous vehicles. As a result, the illustrative embodiments provide a technical effect of providing presence of autonomous vehicles and information associated with vehicles to all types of users within an area.

In the illustrative embodiments, the locations for the number of autonomous vehicles shown in the digital map are real-time locations. As a result, the illustrative embodiments provide a technical effect of providing real-time locations for identified autonomous vehicles around users as the identified autonomous vehicles move over time.

In the illustrative embodiments, the number of autonomous vehicles includes public transportation vehicles and commercial vehicles and the public transportation vehicles and commercial vehicles can be distinguished based on the set of data. As a result, the illustrative embodiments provide a technical effect of distinguishing commercial vehicles and public transportations from identified autonomous vehicles and providing information associated with commercial vehicles and public transportations separately to interested users.

In the illustrative embodiments, the set of data includes global positioning system (GPS) data for the number of autonomous vehicles. As a result, the illustrative embodiments provide a technical effect of using GPS data for the autonomous vehicles to accurately identify the locations for the autonomous vehicles.

A computer system includes a processor set, a set of one or more computer-readable storage media, and program instructions, stored in the set of one or more computer-readable storage media, to cause the processor set to perform the following computer operations. The processor set determines a set of data to be collected from a number of autonomous vehicles in real-time. The set of data includes anonymized data associated with operations for the number of autonomous vehicles. The processor set collects the set of data from the number of autonomous vehicles through internet of things (IoT) devices from the number of autonomous vehicles using a central server. The processor set generates a digital map based on the set of data. Locations for the number of autonomous vehicles are shown in the digital map. The processor set displays the digital map to a number of users within a predefined proximity to the number of autonomous vehicles. As a result, the illustrative embodiments provide a technical effect of identifying and displaying autonomous vehicles around particular users to promote awareness among drivers about the presence of vehicles in autonomous mode.

In the illustrative embodiments, as part of collecting the set of data from the number of autonomous vehicles through internet of things (IoT) devices from the number of autonomous vehicles, the processor set further executes the program instructions to define a communication protocol to allow the number of autonomous vehicles to transmit the set of data to the central server. The processor set further executes the program instructions to identify the internet of things devices from the number of autonomous vehicles. The internet of things devices are associated with operations for the number of autonomous vehicles. The processor set further executes the program instructions to establish connections between the internet of things devices from the number of autonomous vehicles and the central server. The processor set further executes the program instructions to transmit the set of data collected from the internet of things devices to the central server. As a result, the illustrative embodiments provide a technical effect of establishing secure communications between internet of things devices from autonomous vehicles to central servers for data exchange.

In the illustrative embodiments, the transmission for the set of data is enabled when vehicles from the number of autonomous vehicles are engaged in self-driving autonomous mode. As a result, the illustrative embodiments provide a technical effect of identifying autonomous vehicles that drive around particular users without human interventions to promote awareness among drivers about the presence of vehicles in fully autonomous mode.

In the illustrative embodiments, the processor set further executes the program instructions to optimize traffic signage and placement of road obstacles based on the digital map. As a result, the illustrative embodiments provide a technical effect of improving traffic conditions by utilizing the information of autonomous vehicles in an area.

In the illustrative embodiments, the number of users includes pedestrians and users from establishments within the predefined proximity to the number of autonomous vehicles. As a result, the illustrative embodiments provide a technical effect of providing presence of autonomous vehicles and information associated with vehicles to all types of users within an area.

In the illustrative embodiments, the locations for the number of autonomous vehicles shown in the digital map are real-time locations. As a result, the illustrative embodiments provide a technical effect of providing real-time locations for identified autonomous vehicles around users as the identified autonomous vehicles move over time.

In the illustrative embodiments, the number of autonomous vehicles includes public transportation vehicles and commercial vehicles, and the public transportation vehicles and commercial vehicles can be distinguished based on the set of data. As a result, the illustrative embodiments provide a technical effect of distinguishing commercial vehicles and public transportations from identified autonomous vehicles and providing information associated with commercial vehicles and public transportations separately to interested users.

In the illustrative embodiments, the set of data includes global positioning system (GPS) data for the number of autonomous vehicles. As a result, the illustrative embodiments provide a technical effect of using GPS data for the autonomous vehicles to accurately identify the locations for the autonomous vehicles.

In the illustrative embodiments, a computer program product is provided. The computer program product includes a set of one or more computer-readable storage media and program instructions, stored in the set of one or more computer-readable storage media, for causing a processor set to perform the following computer operations. The program instructions are executable by a computer system to determine a set of data to be collected from a number of autonomous vehicles in real-time. The set of data includes anonymized data associated with operations for the number of autonomous vehicles. The program instructions are executable by the computer system to cause the computer system to collect the set of data from the number of autonomous vehicles through internet of things (IoT) devices from the number of autonomous vehicles using a central server. The program instructions are executable by the computer system to cause the computer system to generate a digital map based on the set of data. Locations for the number of autonomous vehicles are shown in the digital map. The program instructions are executable by the computer system to cause the computer system to display the digital map to a number of users within a predefined proximity to the number of autonomous vehicles. As a result, the illustrative embodiments provide a technical effect of identifying and displaying autonomous vehicles around particular users to promote awareness among drivers about the presence of vehicles in autonomous mode.

In the illustrative embodiments, as part of collecting the set of data from the number of autonomous vehicles through internet of things (IoT) devices from the number of autonomous vehicles, the program instructions are further executable by the computer system to cause the computer system to define a communication protocol to allow the number of autonomous vehicles to transmit the set of data to the central server. The program instructions are further executable by the computer system to cause the computer system to identify the internet of things devices from the number of autonomous vehicles. The internet of things devices is associated with operations for the number of autonomous vehicles. The program instructions are further executable by the computer system to cause the computer system to establish connections between the internet of things devices from the number of autonomous vehicles and the central server. The program instructions are further executable by the computer system to cause the computer system to transmit the set of data collected from the internet of things devices to the central server. As a result, the illustrative embodiments provide a technical effect of establishing secure communications between internet of things devices from autonomous vehicles to central servers for data exchange.

In the illustrative embodiments, the transmission for the set of data is enabled when vehicles from the number of autonomous vehicles are engaged in self-driving autonomous mode. As a result, the illustrative embodiments provide a technical effect of identifying autonomous vehicles that drive around particular users without human interventions to promote awareness among drivers about the presence of vehicles in fully autonomous mode.

In the illustrative embodiments, the program instructions are further executable by the computer system to cause the computer system to optimize traffic signage and placement of road obstacles based on the digital map. As a result, the illustrative embodiments provide a technical effect of improving traffic conditions by utilizing the information of autonomous vehicles in an area.

In the illustrative embodiments, the number of users includes pedestrians and users from establishments within the predefined proximity to the number of autonomous vehicles. As a result, the illustrative embodiments provide a technical effect of providing presence of autonomous vehicles and information associated with vehicles to all types of users within an area.

In the illustrative embodiments, the locations for the number of autonomous vehicles shown in the digital map are real-time locations. As a result, the illustrative embodiments provide a technical effect of providing real-time locations for identified autonomous vehicles around users as the identified autonomous vehicles move over time.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

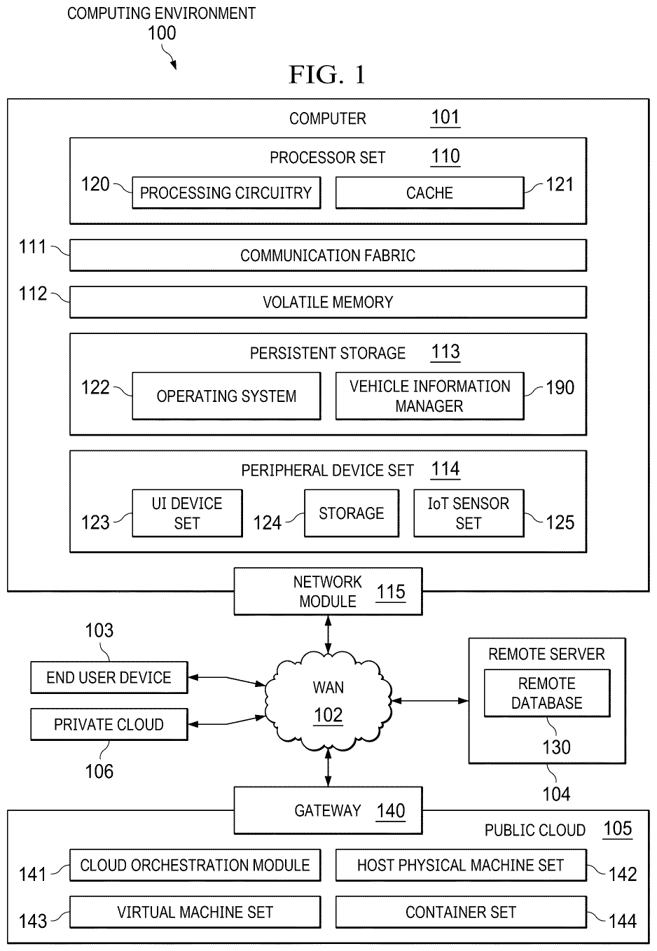

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as vehicle information manager 190. In addition to vehicle information manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and vehicle information manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in vehicle information manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in vehicle information manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that lack of awareness among drivers regarding the presence of autonomous vehicles around the drivers poses significant road safety concerns. This issue can lead to potential accidents and confusions on the road.

The illustrative embodiments also recognize and take into account that road safety can be enhanced and improved by utilizing GPS technology, sensor data, and communication protocols to improve communications between drivers.

In addition, the illustrative embodiments also recognize and take into account that by displaying information associated with autonomous vehicles, drivers can easily identify the presence of autonomous vehicles and adjust their driving behavior accordingly.

Thus, illustrative embodiments of the present invention provide a computer implemented method, computer system, and computer program product for presenting information associated with autonomous vehicles. A processor set determines a set of data to be collected from a number of autonomous vehicles in real-time. The set of data comprises anonymized data associated with operations for the number of autonomous vehicles. The processor set collects the set of data from the number of autonomous vehicles through internet of things (IoT) devices from the number of autonomous vehicles using a central server. The processor set generates a digital map based on the set of data, wherein locations for the number of autonomous vehicles are shown in the digital map. The processor set displays the digital map to a number of users within a predefined proximity to the number of autonomous vehicles.

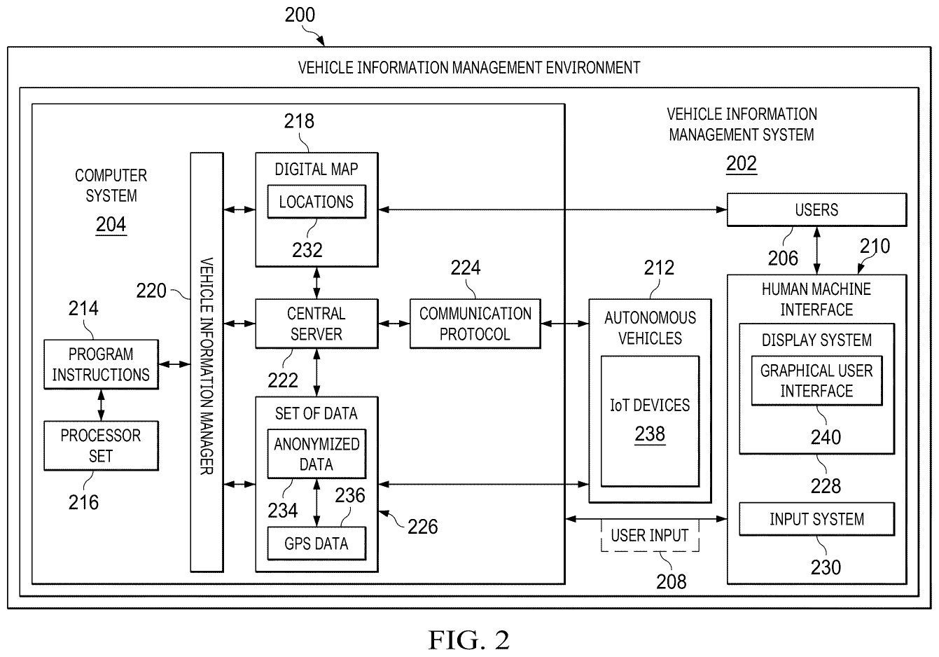

With reference now to FIG. 2, an illustration of a block diagram of a vehicle information management environment is depicted in accordance with an illustrative embodiment. In this illustrative example, vehicle information management environment 200 includes components that can be implemented in hardware such as the hardware shown in computing environment 100 in FIG. 1.

In this illustrative example, vehicle information management system 202 in vehicle information management environment 200 can be used for identifying autonomous vehicles 212 and presenting information associated with autonomous vehicles 212 to users 206. In this illustrative example, vehicle information management system 202 includes computer system 204 which includes vehicle information manager 220. Vehicle information manager 220 is located in computer system 204. Vehicle information manager 220 may be implemented using vehicle information manager 190 in FIG. 1.

Vehicle information manager 220 can be implemented in software, hardware, firmware, or a combination thereof. When software is used, the operations performed by vehicle information manager 220 can be implemented in program instructions configured to run on hardware, such as a processor unit. When firmware is used, the operations performed by vehicle information manager 220 can be implemented in program instructions and data and stored in persistent memory to run on a processor unit. When hardware is employed, the hardware can include circuits that operate to perform the operations in vehicle information manager 220.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, computer system 204 includes set of data 226 received from autonomous vehicles 212. In this illustrative example, autonomous vehicles 212 are vehicles that have the capability to navigate and operate without human intervention. In this illustrative example, autonomous vehicles can have multiple driving modes. For example, autonomous vehicles can be engaged in fully autonomous mode, which is also referred as “self-driving autonomous mode”. Under self-driving autonomous mode, autonomous vehicles are fully autonomous and do not require human intervention at all.

In addition, autonomous vehicles can also be engaged in semi-autonomous mode. In this illustrative example, autonomous vehicles that are engaged in semi-autonomous mode can perform some driving functions without driver's constant input. For example, autonomous vehicles can accelerate and brakes, steering, and parks under semi-autonomous mode without driver's input. However, autonomous vehicles operating under semi-autonomous mode usually require driver to keep their hands on the wheel and the autonomous vehicles often provide visual and audible warnings to ensure that drivers are attentive to the operations of the autonomous vehicles.

As depicted, set of data 226 are received from autonomous vehicles 212. In this illustrative example, set of data 226 includes anonymized data 234. Anonymized data 234 is information from which all personally identifiable information has been removed. In this illustrative example, it is impossible to trace back to an individual using anonymized data 234. In other words, set of data 226 are anonymized such that the identities for owners'autonomous vehicles can be identified using set of data 226.

In this illustrative example, set of data 226 are information associated with real-time operations of autonomous vehicles 212. For example, set of data 226 can include GPS data 236, which is geolocation data that indicates the exact locations for autonomous vehicles 212. In this illustrative example, GPS data 236 can be real-time geolocation data for autonomous vehicles 212 and changes as autonomous vehicles 212 moves. In this illustrative example, autonomous vehicles 212 can include commercial vehicles and public transportation vehicles. Commercial vehicles and public transportation vehicles can be distinguished using set of data 226.

In this illustrative example, set of data 226 can also include sensor data such as real-time environment information received from devices such as Light Detection and Ranging (LiDAR) devices, radar, cameras, and ultrasonic sensors. In addition, set of data 226 can include control system data, communication data, navigation data, diagnostic and maintenance data, or any data associated with operations of autonomous vehicles 212.

In this illustrative example, set of data 226 can be collected in a number of ways. For example, vehicle information manager 220 can utilize central server 222 to collect set of data 226. Central server 222 is a computing system within a network that manages and coordinates resources, processes, and data for connected devices. Central server 222 can be used for handling requests, storing and retrieving data, performing computations, and facilitating communication between devices or other connected servers.

In this illustrative example, communication protocol 224 can be defined to allow autonomous vehicles 212 to transmit set of data 226 to central server 222. Communication protocol 224 is a set of standardized rules and procedures that dictate how data is transmitted, received, and interpreted between devices in a network. In this illustrative example, communication protocol 224 ensures devices in autonomous vehicles 212 can effectively communicate with central server 222 in accordance with security and privacy compliance.

In addition, vehicle information manager 220 can further implement security measures to protect transmitted data such as set of data 226 from unauthorized access or tempering. For example, the security measures can include encryption, authentication mechanisms, and access control protocols.

In this illustrative example, vehicle information manager 220 can first determine types of information to be included in set of data 226. For example, types of information to be included in set of data 226 can include location, speed, direction, navigation, or any type of information associated with operations of autonomous vehicles 212.

Subsequently, vehicle information manager 220 can identify IoT devices 238 in autonomous vehicles 212 to collect set of data 226. In this example, IoT devices 238 are devices for collecting and processing information associated with operations of autonomous vehicles 212 to enable safe and efficient driving for autonomous vehicles 212. IoT devices 238 can include LiDAR sensors, radar sensors, cameras, ultrasonic sensors, GPS modules, inertial measurement units, communication modules, temperature and climate sensors, occupant monitoring sensor, or any IoT device that can be used for collecting and processing information associated with operations for autonomous vehicles 212.

In this illustrative example, vehicle information manager 220 can establish connections between IoT devices 238 in autonomous vehicles 212 and central server 222 using communication protocol 224 such that IoT devices 238 can directly transmit set of data 226 to central server 222. In this illustrative example, the transmission of set of data 226 from IoT devices 238 can be enabled as long as autonomous vehicles 212 are operating. In an alternative example, the transmission of set of data 226 from IoT devices 238 can be enabled when autonomous vehicles 212 or a portion of autonomous vehicles 212 are engaged in self-driving autonomous mode.

In this illustrative example, vehicle information manager 220 can integrate set of data 226 with mapping system to generate digital map 218. Digital map 218 is an electronic version of a geographical map that uses data to represent real-world features. For example, digital map 218 can be a map that includes locations for users 206 and locations 232 for autonomous vehicles 212. In this illustrative example, locations 232 are determined based on GPS data 236 in set of data 226. Locations 232 can be real-time locations for autonomous vehicles 212.

In an alternative example, set of data 226 can be collected from a portion of IoT devices 238 that is activated when autonomous vehicles 212 are engaged in self-driving autonomous mode. In other words, set of data 226 may not include information from other devices in IoT devices 238 that are not activated when autonomous vehicles 212 are engaged in self-driving autonomous mode. In this illustrative example, the above mentioned feature allows users to have an additional option to select route with no or minimal autonomous vehicles vehicle presence.

In this illustrative example, users 206 are individuals and entities that are within a predefined proximity to autonomous vehicles. For example, users 206 can be individuals and entities that are within 1 miles of autonomous vehicles 212, 2 miles of autonomous vehicles 212, 5 miles of autonomous vehicles 212, or any predefined proximity. In this illustrative example, users 206 can include drivers, pedestrians, and users from establishments within the predefined proximity to autonomous vehicles 212. Establishments are physical places where specific activities occur. For example, establishments can include commercial buildings such as stores and restaurants, educational institutions such as gyms and parks, healthcare facilities such as hospitals and clinic, or recreational centers such as gyms and parks.

In other words, users 206 can view real-time information such as real-time locations of autonomous vehicles 212 using digital map 218 to be aware of autonomous vehicles within a proximity to users 206.

In this illustrative example, users 206 can interact with computer system 204 through user inputs to computer system 204. For example, computer system 204 can receive user input 208 that includes request to view digital map 218 for locations 232.

In this illustrative example, user input 208 can be generated by users 206 using human machine interface (HMI) 210. As depicted, human machine interface 210 includes display system 228 and input system 230. Display system 228 is a physical hardware system and includes one or more display devices on which graphical user interface 240 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, users 206 are people that can interact with graphical user interface 240 through user input 208 generated by input system 230. Input system 230 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, users 206 can view digital map 218 and locations 232 through graphical user interface 240.

In addition, vehicle information manager 220 can use set of data 226 and digital map 218 for other applications. For example, set of data 226 and digital map 218 can be used for smart city planning by sharing set of data 226 and digital map 218 with local authorities to optimize traffic signages and placement of road obstacles to improve traffic conditions. In another example, vehicle information manager 220 can share set of data 226 and digital map 218 with local hospitals and public transport authorities to improve emergency services and public transportations.

In an alternative example, vehicle information manager 220 can be incorporated with existing taxis applications to allow consumers to select/deselect autonomous vehicles for a ride.

In yet another example, vehicle information manager 220 can provide the functionality for users 206 to filter between private vehicles and public vehicles. In yet another example, vehicle information manager 220 can provide additional features of displaying safe level for autonomous vehicles 212 and historical brand incidents identified in a color-coded vehicles in digital map 218.

In one illustrative example, one or more solutions are present that overcome a problem with presenting information associated with autonomous vehicles within a proximity to users. As a result, one or more technical solutions may provide an ability to increase the efficiency and performance in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which vehicle information manager 220 in computer system 204 enables real-time display of locations for autonomous vehicles. In particular, vehicle information manager 220 transforms computer system 204 into a special purpose computer system as compared to currently available general computer systems that do not have vehicle information manager 220.

In the illustrative example, the use of vehicle information manager 220 in computer system 204 integrates processes into a practical application for displaying real-time locations of autonomous vehicles. In other words, vehicle information manager 220 in computer system 204 is directed to a practical application of processes integrated into vehicle information manager 220 in computer system 204 that supports presenting locations and information for autonomous vehicles to users within a proximity.

For example, vehicles that approach a busy intersection can experience confusion due to difficulties in determining the driving modes of other vehicles. This confusion can lead to hesitation, misjudgment, and an increased risk of accidents.

In this illustrative example, vehicle information manager 220 can be used to perform IoT network analysis that helps to accurately determine the driving modes of vehicles at the intersection. For example, vehicle information manager 220 can identify intentions of nearby vehicles to ensure that autonomous vehicles can confidently predict and respond to the actions of human-driven vehicles and other autonomous vehicles. Vehicle information manager 220 can further perform real-time traffic pattern analysis, predictive analytics, and alerts provide enhanced situational awareness, to ensure smoother and safer interactions at the intersection. In this illustrative example, drivers and autonomous systems receive clear, timely warnings when potential issues arise, reducing confusion and enhancing overall safety.

In another example, there may be situations where autonomous vehicles fail to correctly identify the driving modes of nearby traditional vehicles. This can lead to unexpected and potentially hazardous behaviors, causing uncertainty and distrust in autonomous technology. In this illustrative example, the vehicles can benefit from vehicle information manager 220 through improved real-time data processing, vehicle to vehicle communication optimization, and predictive analytics. Vehicle information manager 220 can be used for ensuring that autonomous vehicles accurately identify the driving modes of nearby vehicles and predict their actions. In this illustrative example, any anomalies or potential issues can be detected early to ensure deployment of proactive safety measures. In this illustrative example, drivers and autonomous vehicles can receive clear warnings to reduce the likelihood of unpredictable behaviors and enhance trust in the coexistence of autonomous vehicles and traditional vehicles.

The illustration of vehicle information management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, if autonomous vehicles 212 do not support transmission of data to central server 222, set of data 226 can include information collected from crowdsourcing.

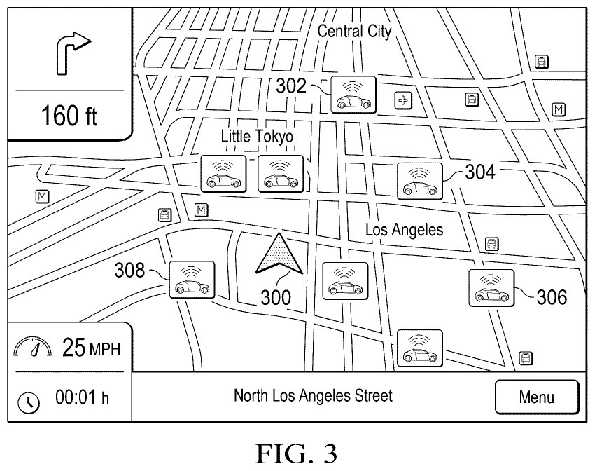

With reference now to FIG. 3, an illustration of a digital map is shown in accordance with an illustrative embodiment. In this illustrative example, the digital map shown in FIG. 3 can be an example of digital map 218 in FIG. 2.

In FIG. 3, the digital map shows locations of user 300 and the autonomous vehicles around user 300 within a proximity. In other words, user 300 is a representation of a vehicle driven by a user. In this illustrative example, user 300 can be an example of users 206 in FIG. 2.

As depicted, the autonomous vehicles around user 300 are shown on the digital map shown in FIG. 3. In this illustrative example, user 300 can get information associated with the autonomous vehicles around user 300 by viewing the digital map shown in FIG. 3. For example, the digital map shown in FIG. 3 shows that autonomous vehicle 308 is close to user 300 while autonomous vehicle 302, autonomous vehicle 304, and autonomous vehicle 306 are further away from user 300. In this illustrative example, autonomous vehicle 302, autonomous vehicle 304, and autonomous vehicle 306 can be examples of autonomous vehicles 212 in FIG. 2.

As depicted, the digital map shown in FIG. 3 can further include other information. For example, the digital map shown in FIG. 3 can include navigation information for user 300, geolocation information for user 300, and other information associated with operations of vehicles driven by user 300. In addition, digital map shown in FIG. 3 can also include information associated with operations of autonomous vehicles around user 300.

The illustration of digital map in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, the functionality of displaying autonomous vehicles within a proximity to a user can be integrated into existing mapping services or working as a standalone application that shows real-time locations autonomous vehicles within a proximity to a user on a digital map.

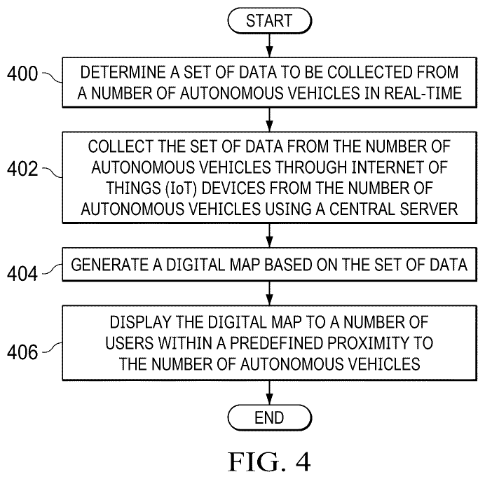

With reference now to FIG. 4, a flowchart illustrating a process for presenting information of nearby autonomous vehicles is shown in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process can be implemented in vehicle manager 220 in computer system 204 in FIG. 2.

The process begins by determining a set of data to be collected from a number of autonomous vehicles in real-time (step 400). In step 400, the set of data includes anonymized data associated with operations for the number of autonomous vehicles. The process collects the set of data from the number of autonomous vehicles through internet of things (IoT) devices from the number of autonomous vehicles using a central server (step 402).

The process generates a digital map based on the set of data (step 404). In step 404, locations for the number of autonomous vehicles are shown in the digital map. The process displays the digital map to a number of users within a predefined proximity to the number of autonomous vehicles (step 406). The process terminates thereafter.

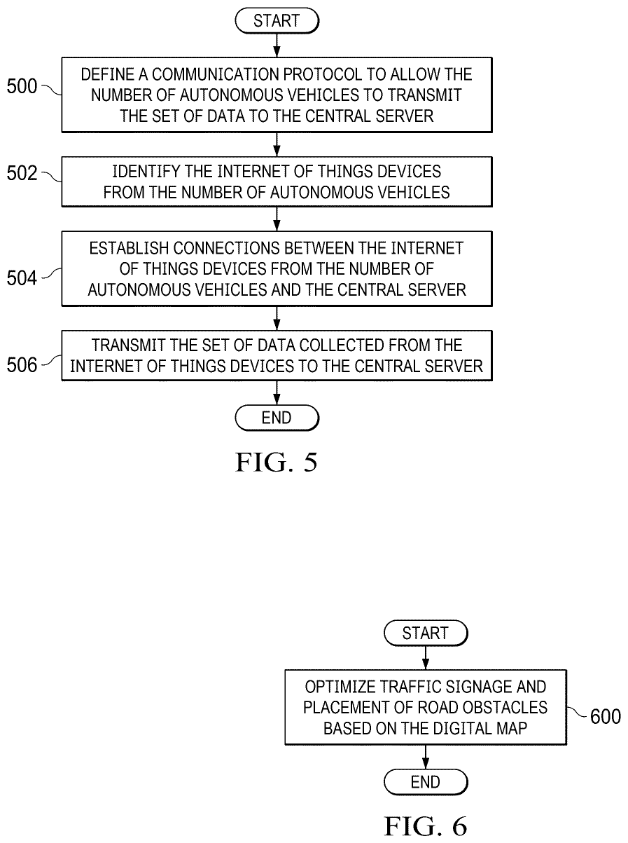

With reference now to FIG. 5, a flowchart illustrating a process for collecting data from autonomous vehicles is shown in accordance with an illustrative embodiment. The process in this flowchart is an example of an implementation for step 402 in FIG. 4.

The process begins by defining a communication protocol to allow the number of autonomous vehicles to transmit the set of data to the central server (step 500). The process identifies the internet of things devices from the number of autonomous vehicles (step 502). In step 502, the internet of things devices are associated with operations for the number of autonomous vehicles. The process establishes connections between the internet of things devices from the number of autonomous vehicles and the central server (step 504). The process transmits the set of data collected from the internet of things devices to the central server (step 506). The process terminates thereafter.

With reference now to FIG. 6, a flowchart illustrating a process for optimizing traffic signage and placement of road obstacles is shown in accordance with an illustrative embodiment. The process in this figure is an example of an additional step that can be performed with the steps in FIG. 4.

The process begins by optimizing traffic signage and placement of road obstacles based on the digital map (step 600). The process terminates thereafter.

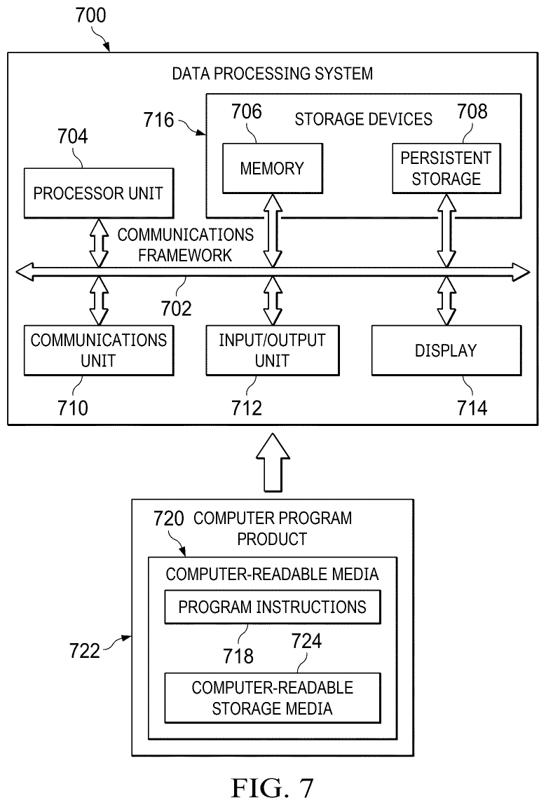

Turning now to FIG. 7, a block diagram of a data processing system is depicted in accordance with an illustrative embodiment. Data processing system 700 can be used to implement computers and computing devices in computing environment 100 in FIG. 1. Data processing system 700 can also be used to implement computer system 204 in FIG. 2. In this illustrative example, data processing system 700 includes communications framework 702, which provides communications between processor unit 704, memory 706, persistent storage 708, communications unit 710, input/output (I/O) unit 712, and display 714. In this example, communications framework 702 takes the form of a bus system.

Processor unit 704 serves to execute instructions for software that can be loaded into memory 706. Processor unit 704 includes one or more processors. For example, processor unit 704 can be selected from at least one of a multicore processor, a central processing unit (CPU), a graphics processing unit (GPU), a physics processing unit (PPU), a digital signal processor (DSP), a network processor, or some other suitable type of processor. Further, processor unit 704 can be implemented using one or more heterogeneous processor systems in which a main processor is present with secondary processors on a single chip. As another illustrative example, processor unit 704 can be a symmetric multi-processor system containing multiple processors of the same type on a single chip.

Memory 706 and persistent storage 708 are examples of storage devices 716. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 716 may also be referred to as computer-readable storage devices in these illustrative examples. Memory 706, in these examples, can be, for example, a random-access memory or any other suitable volatile or non-volatile storage device. Persistent storage 708 may take various forms, depending on the particular implementation.

For example, persistent storage 708 may contain one or more components or devices. For example, persistent storage 708 can be a hard drive, a solid-state drive (SSD), a flash memory, a rewritable optical disk, a rewritable magnetic tape, or some combination of the above. The media used by persistent storage 708 also can be removable. For example, a removable hard drive can be used for persistent storage 708.

Communications unit 710, in these illustrative examples, provides for communications with other data processing systems or devices. In these illustrative examples, communications unit 710 is a network interface card.

Input/output unit 712 allows for input and output of data with other devices that can be connected to data processing system 700. For example, input/output unit 712 may provide a connection for user input through at least one of a keyboard, a mouse, or some other suitable input device. Further, input/output unit 712 may send output to a printer. Display 714 provides a mechanism to display information to a user.

Instructions for at least one of the operating system, applications, or programs can be located in storage devices 716, which are in communication with processor unit 704 through communications framework 702. The processes of the different embodiments can be performed by processor unit 704 using computer-implemented instructions, which may be located in a memory, such as memory 706.

These instructions are referred to as program instructions, computer usable program instructions, or computer-readable program instructions that can be read and executed by a processor in processor unit 704. The program instructions in the different embodiments can be embodied on different physical or computer-readable storage media, such as memory 706 or persistent storage 708.

Program instructions 718 are located in a functional form on computer-readable media 720 that is selectively removable and can be loaded onto or transferred to data processing system 700 for execution by processor unit 704. Program instructions 718 and computer-readable media 720 form computer program product 722 in these illustrative examples. In the illustrative example, computer-readable media 720 is computer-readable storage media 724.

Computer-readable storage media 724 is a physical or tangible storage device used to store program instructions 718 rather than a medium that propagates or transmits program instructions 718. Computer-readable storage media 724, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 718 can be transferred to data processing system 700 using a computer-readable signal media. The computer-readable signal media are signals and can be, for example, a propagated data signal containing program instructions 718. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 720” can be singular or plural. For example, program instructions 718 can be located in computer-readable media 720 in the form of a single storage device or system. In another example, program instructions 718 can be located in computer-readable media 720 that is distributed in multiple data processing systems. In other words, some instructions in program instructions 718 can be located in one data processing system while other instructions in program instructions 718 can be located in one data processing system. For example, a portion of program instructions 718 can be located in computer-readable media 720 in a server computer while another portion of program instructions 718 can be located in computer-readable media 720 located in a set of client computers.

The different components illustrated for data processing system 700 are not meant to provide architectural limitations to the manner in which different embodiments can be implemented. In some illustrative examples, one or more of the components may be incorporated in or otherwise form a portion of another component. For example, memory 706, or portions thereof, may be incorporated in processor unit 704 in some illustrative examples. The different illustrative embodiments can be implemented in a data processing system including components in addition to or in place of those illustrated for data processing system 700. Other components shown in FIG. 7 can be varied from the illustrative examples shown. The different embodiments can be implemented using any hardware device or system capable of running program instructions 718.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method, the computer implemented method comprising:
determining, by a processor set, a set of data to be collected from a number of autonomous vehicles in real-time, wherein the set of data comprises anonymized data associated with operations for the number of autonomous vehicles;
collecting, by the processor set using a central server, the set of data from the number of autonomous vehicles through internet of things (IoT) devices from the number of autonomous vehicles;
generating, by the processor set, a digital map based on the set of data, wherein locations for the number of autonomous vehicles are shown in the digital map; and
displaying, by the processor set, the digital map to a number of users within a predefined proximity to the number of autonomous vehicles.

2. The computer implemented method of claim 1, wherein the collecting, by the processor set, the set of data from the number of autonomous vehicles through internet of things (IoT) devices from the number of autonomous vehicles comprises:
defining, by the processor set, a communication protocol to allow the number of autonomous vehicles to transmit the set of data to the central server;
identifying, by the processor set, the internet of things devices from the number of autonomous vehicles, wherein the internet of things devices is associated with operations for the number of autonomous vehicles;
establishing, by the processor set, connections between the internet of things devices from the number of autonomous vehicles and the central server; and
transmitting, by the processor set, the set of data collected from the internet of things devices to the central server.

3. The computer implemented method of claim 2, wherein the transmission for the set of data is enabled when vehicles from the number of autonomous vehicles are engaged in self-driving autonomous mode.

4. The computer implemented method of claim 1, further comprising:
optimizing, by the processor set, traffic signage and placement of road obstacles based on the digital map.

5. The computer implemented method of claim 1, wherein the number of users comprises pedestrians and users from establishments within the predefined proximity to the number of autonomous vehicles.

6. The computer implemented method of claim 1, wherein the locations for the number of autonomous vehicles shown in the digital map are real-time locations.

7. The computer implemented method of claim 1, wherein the number of autonomous vehicles comprises public transportation vehicles and commercial vehicles, and wherein the public transportation vehicles and commercial vehicles can be distinguished based on the set of data.

8. The computer implemented method of claim 1, wherein the set of data comprises global positioning system (GPS) data for the number of autonomous vehicles.

9. A computer system, comprising:
a processor set;
a set of one or more computer-readable storage media; and
program instructions stored on the set of one or more storage media to cause the processor set to perform operations comprising:
determining a set of data to be collected from a number of autonomous vehicles in real-time, wherein the set of data comprises anonymized data associated with operations for the number of autonomous vehicles;
collecting the set of data from the number of autonomous vehicles through internet of things (IoT) devices from the number of autonomous vehicles using a central server;
generating a digital map based on the set of data, wherein locations for the number of autonomous vehicles are shown in the digital map; and
displaying the digital map to a number of users within a predefined proximity to the number of autonomous vehicles.

10. The computer system of claim 9, wherein the collecting the set of data from the number of autonomous vehicles through internet of things (IoT) devices from the number of autonomous vehicles using a central server comprises:
defining a communication protocol to allow the number of autonomous vehicles to transmit the set of data to the central server;
identifying the internet of things devices from the number of autonomous vehicles, wherein the internet of things devices is associated with operations for the number of autonomous vehicles;
establishing connections between the internet of things devices from the number of autonomous vehicles and the central server; and
transmitting the set of data collected from the internet of things devices to the central server.

11. The computer system of claim 10, wherein the transmission for the set of data is enabled when vehicles from the number of autonomous vehicles are engaged in self-driving autonomous mode.

12. The computer system of claim 9, wherein the operations further comprise:
optimizing traffic signage and placement of road obstacles based on the digital map.

13. The computer system of claim 9, wherein the number of users comprises pedestrians and users from establishments within the predefined proximity to the number of autonomous vehicles.

14. The computer system of claim 9, wherein the locations for the number of autonomous vehicles shown in the digital map are real-time locations.

15. The computer system of claim 9, wherein the set of data comprises global positioning system (GPS) data for the number of autonomous vehicles.

16. A computer program product, comprising:
a set of one or more computer-readable storage media;
program instructions stored in the set of one or more computer-readable storage media to perform operations comprising:
determining, by a processor set, a set of data to be collected from a number of autonomous vehicles in real-time, wherein the set of data comprises anonymized data associated with operations for the number of autonomous vehicles;
collecting, by the processor set, the set of data from the number of autonomous vehicles through internet of things (IoT) devices from the number of autonomous vehicles;
generating, by the processor set using a central server, a digital map based on the set of data, wherein locations for the number of autonomous vehicles are shown in the digital map; and
displaying, by the processor set, the digital map to a number of users within a predefined proximity to the number of autonomous vehicles.

17. The computer program product of claim 16, wherein the collecting, by the processor set, the set of data from the number of autonomous vehicles through internet of things (IoT) devices from the number of autonomous vehicles comprises:
defining, by the processor set, a communication protocol to allow the number of autonomous vehicles to transmit the set of data to the central server;
identifying, by the processor set, the internet of things devices from the number of autonomous vehicles, wherein the internet of things devices is associated with operations for the number of autonomous vehicles;
establishing, by the processor set, connections between the internet of things devices from the number of autonomous vehicles and the central server; and
transmitting, by the processor set, the set of data collected from the internet of things devices to the central server.

18. The computer program product of claim 17, wherein the transmission for the set of data is enabled when vehicles from the number of autonomous vehicles are engaged in self-driving autonomous mode.

19. The computer program product of claim 16, wherein the operations further comprise:
optimizing, by the processor set, traffic signage and placement of road obstacles based on the digital map.

20. The computer program product of claim 16, wherein the locations for the number of autonomous vehicles shown in the digital map are real-time locations.
